(19) United States
(12) Patent Application Publication
(10) Pub. No.: US 2011/0140961 A1
(43) Pub. Date: Jun. 16, 2011

(54) Mobile phone cradle with GPS and Bluetooth functionality

(76) Inventors: Chen-Chen Yeh, Taipei City (TW); Chun-Nan Yeh, Taipei City (TW); Hsien-Yao Chang, Taipei City (TW); Wen-Chieh Kuo, Taipei City (TW); Tzu-Tun Tai, Taipei City (TW); Bo-Han Hsieh, Taipei City (TW); Chih-Yeh Lin, Taipei City (TW)

(21) Appl. No.: 12/954,586

(22) Filed: Nov. 24, 2010

Related U.S. Application Data
(60) Provisional application No. 61/286,027, filed on Dec. 14, 2009.

(51) Int. Cl. G01S 19/05

(52) U.S. Cl. 342/357.42

(57) ABSTRACT

A method of providing Global Positioning System (GPS) signals received by a cradle to a portable electronic device installed in the cradle includes mounting the portable electronic device in the cradle for establishing electrical connection between a first connector of the cradle and a second connector of the portable electronic device, receiving GPS signals through a GPS receiver of the cradle, converting the received GPS signals into GPS data signals, transmitting the GPS data signals from the cradle to the portable electronic device via the first and second connectors, and the portable electronic device using the GPS data signals for aiding the portable electronic device in determining current position coordinates of the portable electronic device.

### CROSS REFERENCE TO RELATED APPLICATIONS

This application claims the benefit of U.S. Provisional Application No. 61/286,027, filed on Dec. 14, 2009 and entitled “Mobile phone cradle with GPS and Bluetooth functionality”, the contents of which are incorporated herein by reference.

### BACKGROUND OF THE INVENTION

1. Field of the Invention

The invention relates to a cradle for a mobile phone, and more particularly, to a cradle providing Global Positioning System (GPS) signals to a mobile phone installed in the cradle as well as providing speakerphone functionality for the mobile phone through the Bluetooth wireless protocol.

2. Description of the Prior Art

With the increasing popularity and increasing processing power of portable electronic devices, recently more and more devices have started to provide navigation assistance functions. As many people now have mobile phones, a current trend is for mobile phones to assist users with determining the user's current location as well as offering navigation instructions to the user.

In order to determine the user's current location, the mobile phone requires some means of knowing the current location of the mobile phone. An approximate location of the mobile phone can be determined by knowing which base station or base stations the mobile phone is currently in communication with. More precise location data can be obtained if the mobile phone contains its own GPS receiver.

However, some mobile phones and some other portable electronic devices either do not contain a GPS receiver, or the provided GPS receiver is not sufficiently accurate enough to provide precise GPS location data to the user. For example, the iPhone® made by Apple® contains a built-in GPS receiver, but some users find the accuracy of the built-in GPS receiver to be lacking. Furthermore, some users find the built in speaker of the iPhone® to be of insufficient volume, making it difficult to use the iPhone® in speakerphone mode.

Therefore, there exists a need for providing both GPS signals and speakerphone functionality to mobile phones and other portable electronic devices in order to overcome these problems.

### SUMMARY OF THE INVENTION

It is therefore one of the primary objectives of the claimed invention to provide a cradle for providing Global Positioning System (GPS) signals to a mobile phone installed in the cradle as well as providing speakerphone functionality for the mobile phone through the Bluetooth wireless protocol. The cradle can also be used in conjunction with other portable electronic devices besides mobile phones as well.

According to an exemplary embodiment of the claimed invention, a method of providing Global Positioning System (GPS) signals received by a cradle to a portable electronic device installed in the cradle is disclosed. The method includes mounting the portable electronic device in the cradle for establishing electrical connection between a first connector of the cradle and a second connector of the portable electronic device, receiving GPS signals through a GPS receiver of the cradle, converting the received GPS signals into GPS data signals, transmitting the GPS data signals from the cradle to the portable electronic device via the first and second connectors, and the portable electronic device using the GPS data signals for aiding the portable electronic device in determining current position coordinates of the portable electronic device.

According to yet another exemplary embodiment of the claimed invention, a cradle for providing Global Positioning System (GPS) signals received by the cradle to a portable electronic device installed in the cradle is disclosed. The cradle includes a first connector formed for receiving a second connector of the portable electronic device and establishing electrical connection between the first connector and the second connector when the portable electronic device is mounted in the cradle, a GPS receiver for receiving GPS signals indicating a current position of the cradle, and a processor for converting the received GPS signals into GPS data signals and transmitting the GPS data signals from the cradle to the portable electronic device via the first and second connectors. The portable electronic device uses the GPS data signals for aiding the portable electronic device in determining current position coordinates of the portable electronic device.

It is an advantage that the cradle can provide accurate GPS signals to the portable electronic device through the first connector of the cradle for allowing the portable electronic device to receive highly accurate GPS data signals. It is another advantage that the cradle contains a Bluetooth transceiver, a microphone, and a speaker for allowing the cradle to provide high quality speakerphone functionality for the portable electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a functional block diagram of a mobile phone mounted in and electrically connected to a cradle according to the present invention.

FIG. 2 is a top-front perspective view of the cradle according to the present invention.

FIG. 3 is a bottom-rear perspective view of the cradle according to the present invention.

FIG. 4 is a view of the left side of the cradle according to the present invention.

FIG. 5 is a flowchart illustrating the cradle detecting and beginning communication with the mobile phone.

FIG. 6 is a flowchart illustrating the cradle entering a sleep mode or hibernation mode when not in use.

### DETAILED DESCRIPTION

The present invention provides a cradle for receiving a portable electronic device such as a mobile phone. The cradle is well suited for use in vehicles, when the user does not have the opportunity to hold the portable electronic device. The cradle can be used for providing speakerphone functionality for the mobile phone, which is particularly useful when the phone needs to be used in hands-free mode. Furthermore, the cradle provides a physical mount for the mobile phone and also provides GPS data signals to the mobile phone, which allows navigation data displayed on the mobile phone to be conveniently viewed while driving.

Although the following disclosure will repeatedly refer to the cradle being used in conjunction with a mobile phone, any portable electronic device capable of receiving GPS data signals from the cradle can be in fact be used.

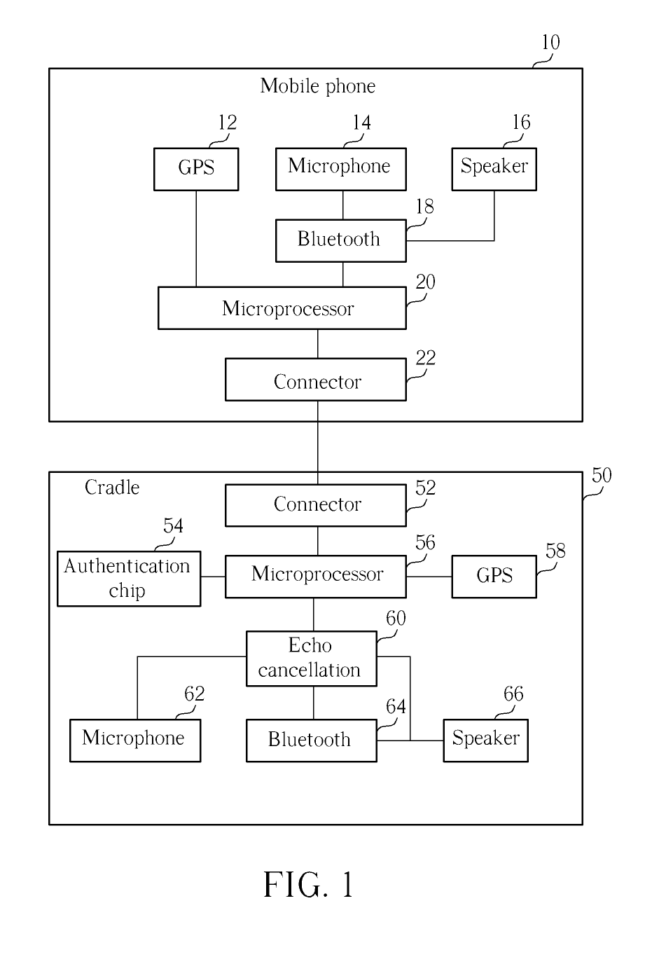

Please refer to FIG. 1. FIG. 1 shows a functional block diagram of a mobile phone 10 mounted in and electrically connected to a cradle 50 according to the present invention. The mobile phone 10 optionally has a GPS receiver 12 for receiving GPS signals indicating the position of the mobile phone 10. The mobile phone 10 also has a microphone 14 for receiving voice input from a user of the mobile phone 10 as well as a speaker 16 or a receiver for outputting sound to the user. The mobile phone 10 also contains a Bluetooth transceiver 18, which allows the mobile phone 10 to operate in hands-free mode using external devices. A microprocessor 20 is used to control the operation of the mobile phone 10, and a connector 22 is used to communicate with external devices.

The cradle 50 contains a connector 52 which links together with and electrically communicates with the connector 22 of the mobile phone 10. A GPS receiver 58 is used to receive highly accurate GPS signals indicating the position of the cradle 50. A microprocessor 56 is used to control operation of the electronic components of the mobile phone 10, as well as for converting the GPS signals received by the GPS receiver 58 into data messages conforming to the National Marine Electronics Association (NMEA) message standard before sending these NMEA messages to the microprocessor 20 of the mobile phone 10 via the connectors 52 and 22. The microprocessor 56 may be a single general microprocessor or may be more than one microprocessor including a digital signal processor (DSP) or any application specific processor.

In an embodiment, the mobile phone 10 is an iPhone® made by Apple®, in which case the connector 52 would also be compatible with other Apple® portable electronic devices such an iPod® or iPod touch®. If the mobile phone 10 is a device containing restrictions on which accessories can be used with the mobile phone 10, as the iPhone® contains, then the cradle 50 must contain a proper authentication chip 54 for verifying that the cradle 50 is approved for use with the mobile phone 10.

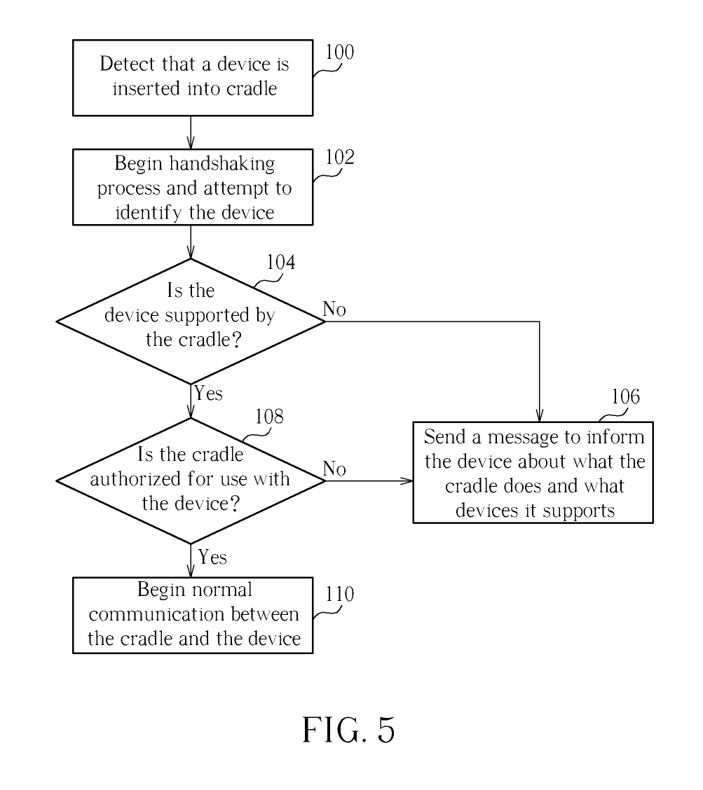

Please refer to FIG. 5. FIG. 5 is a flowchart illustrating the cradle 50 detecting and beginning communication with the mobile phone 10. Steps contained in the flowchart will be explained below.

Step 100: Detect that a device such as the mobile phone 10 is inserted into the cradle 50. For example, when the mobile phone 10 is inserted into the cradle 50, the microprocessor 56 of the cradle 50 is able to sense signals received from the mobile phone 10 via the connector 22 of the mobile phone 10 and the connector 52 of the cradle 50. The signals received can be power signals, such as a system voltage of the device or can be data signals from the device.

Step 102: Begin a handshaking process between the device and the cradle 50 and attempt to identify the mobile phone 10.

Step 104: Determine if the device is supported by the cradle 50. If so, go to step 108. If not, go to step 106.

Step 106: The microprocessor 56 of the cradle 50 sends a message to inform the device about what the cradle 50 does and what devices the cradle 50 supports.

Step 108: Determine if the cradle 50 is authorized for use with the device. As mentioned above, the authentication chip 54 may be used for verifying that the cradle 50 is approved for use with the mobile phone 10 or other such device. If the cradle 50 is authorized, go to step 110. Otherwise, go to step 106.

Step 110: Begin normal communication between the cradle 50 and the device.

The cradle 50 also contains a microphone 62 for receiving voice input from the user and converting this voice input into sound data. A Bluetooth transceiver 64 is used for transmitting sound data from the microphone 62 to the Bluetooth transceiver 18 of the mobile phone 10. The Bluetooth transceiver 64 also receives sound data from Bluetooth transceiver 18 the mobile phone 10 and outputs the sound data through a speaker 66. With the combination of the Bluetooth transceiver 64, the microphone 62, and the speaker 66, the cradle 50 can replace the microphone 14 and the speaker 16 of the mobile phone 10, and provide speakerphone functionality for using the mobile phone 10 in hands-free mode. An echo cancellation module 60 monitors sound data output through the speaker 66 and sound data input through the microphone 62 and removes echo data to improve sound quality. The echo cancellation module 60 then provides the modified sound data to the Bluetooth transceiver 64, where it is sent to the mobile phone 10 for transmission to the other party that is communicating with the user of the mobile phone 10.

Depending on the accuracy of the GPS receiver 12, if present, in the mobile phone 10, the GPS data signals received by the GPS receiver 58 of the cradle 50 can be used to supplement the GPS data signals received directly by the GPS receiver 12 of the mobile phone 10 for determining the current position coordinates of the mobile phone 10. The exact scheme used for determining GPS data signal supplementing is left up to the maker of the mobile phone 10. In other cases, where the GPS receiver 12 of the mobile phone 10 is either not present or of not sufficient accuracy, then the mobile phone 10 can solely rely on the GPS data signals received by the GPS receiver 58 of the cradle 50 for determining the current position coordinates of the mobile phone 10.

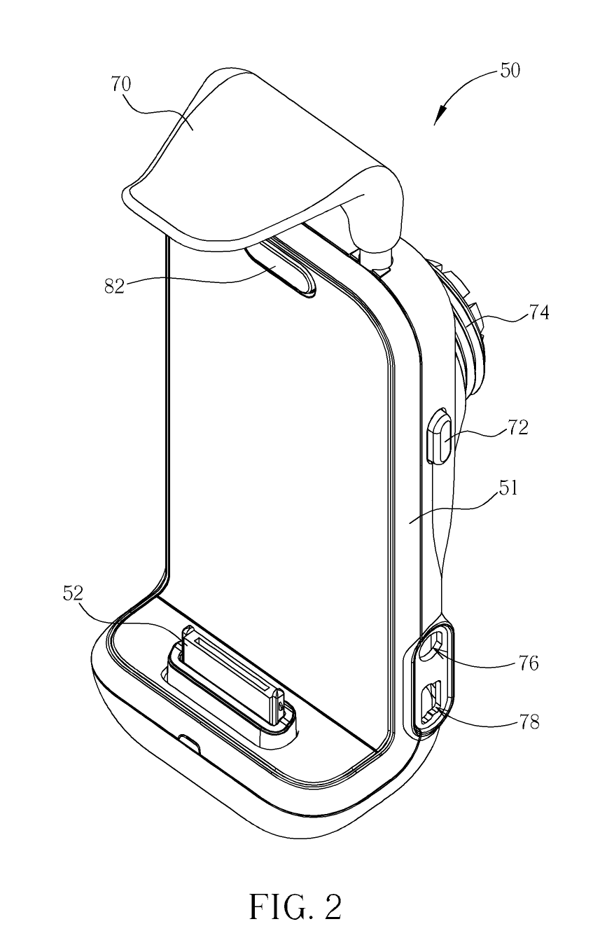

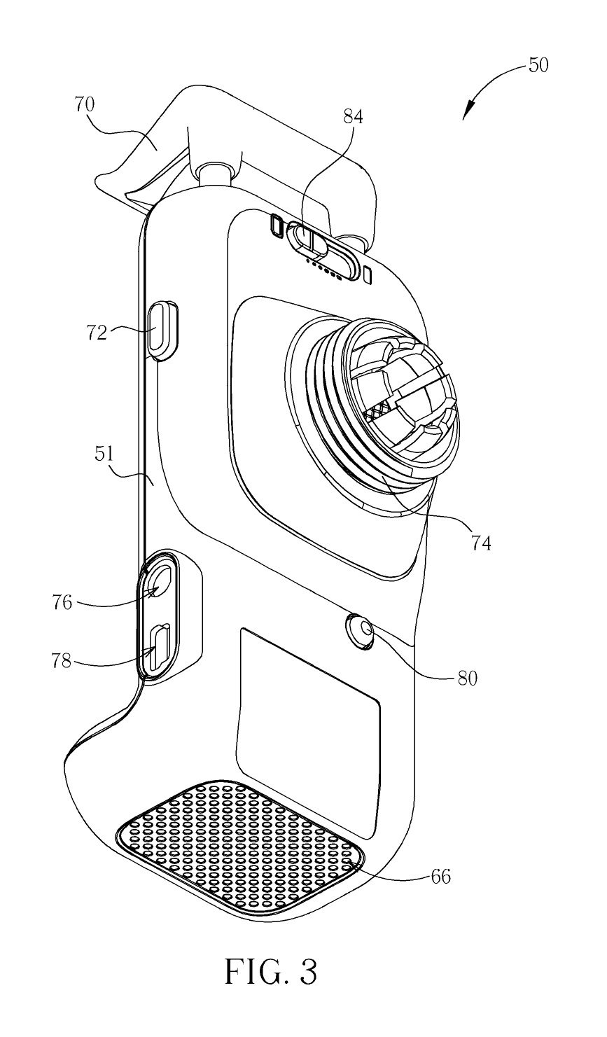

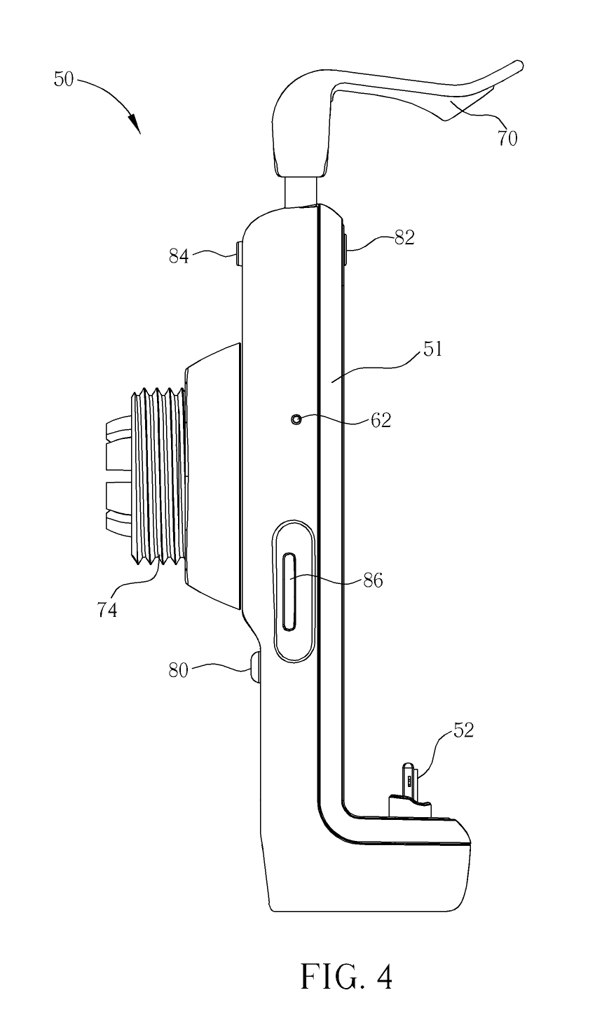

Please refer to FIGS. 2-4. FIG. 2 is a top-front perspective view of the cradle 50 according to the present invention. FIG. 3 is a bottom-rear perspective view of the cradle 50 according to the present invention. FIG. 4 is a view of the left side of the cradle 50 according to the present invention. The front of the cradle 50 is defined as the portion of the cradle 50 where the mobile phone 10 is placed into the cradle 50. The connector 52 is formed on the bottom portion of the front of housing 51 of the cradle 50 for receiving the mobile phone 10. A top clamp 70 secures the top of the mobile phone 10 in place, and a rubber support 82 protrudes from the housing 51 of the cradle 50 for preventing the phone from shaking while installed in the cradle 50. The connector 52, the top clamp 70, and the rubber support 82 provide at least three points where the mobile phone 10 is securely positioned in the cradle 50.

A height-adjust release button 72 is formed on the right side of the housing 51, and when pressed, the height-adjust release button 72 allows the top clamp 70 to be raised for allowing the mobile phone 10 to be inserted into or released from the cradle 50. The top clamp 70 can be lowered by applying a small amount of pressure on the top clamp 70, and pressing the height-adjust release button 72 is not necessary in order to lower the height of the top clamp 70. Similarly, the degree to which the rubber support 82 protrudes from the housing 51 can be controlled by protruding adjuster 84 formed on the back of the housing 51. Moving the protruding adjuster 84 left or right controls how much the rubber support 82 protrudes out from the housing 51.

A threaded mount 74 can be used for mounting the cradle 50 on an external mounting device, which allows the cradle 50 to be positioned in a variety of places. Audio output port 76 allows the sound to be output to another device such as headphones or stereo system of the car instead of outputting sound through the speaker 66 of the cradle 50 located at the bottom of the housing 51. The audio output port 76 may be a standard 3.5 mm headphone jack or any other port. Power can be supplied to the cradle 50 through power port 78. For convenience, the power port 78 may be a standard port such as a mini-Universal Serial Bus (mini-USB) port. A power cable can have a mini-USB plug on one end and a standard car cigarette lighter plug on the other end for receiving power from the 12V cigarette lighter socket in a car. Once power is supplied to the cradle 50 through the power port 78, the received power can be used to charge the mobile phone 10 via the connector 52 of the cradle 50 and the connector 22 of the mobile phone 10.

A volume adjuster knob 86 is located on the left side of the housing 51 for allowing the user to adjust the volume of sound output through the speaker 66 or the audio output port 76. If for some reason the Bluetooth connection between the Bluetooth transceiver 64 of the cradle 50 and the Bluetooth transceiver 18 of the mobile phone 10 is disrupted, the user can press a Bluetooth reset button 80 located on the back of the housing 51 in order to try and reestablish the Bluetooth connection.

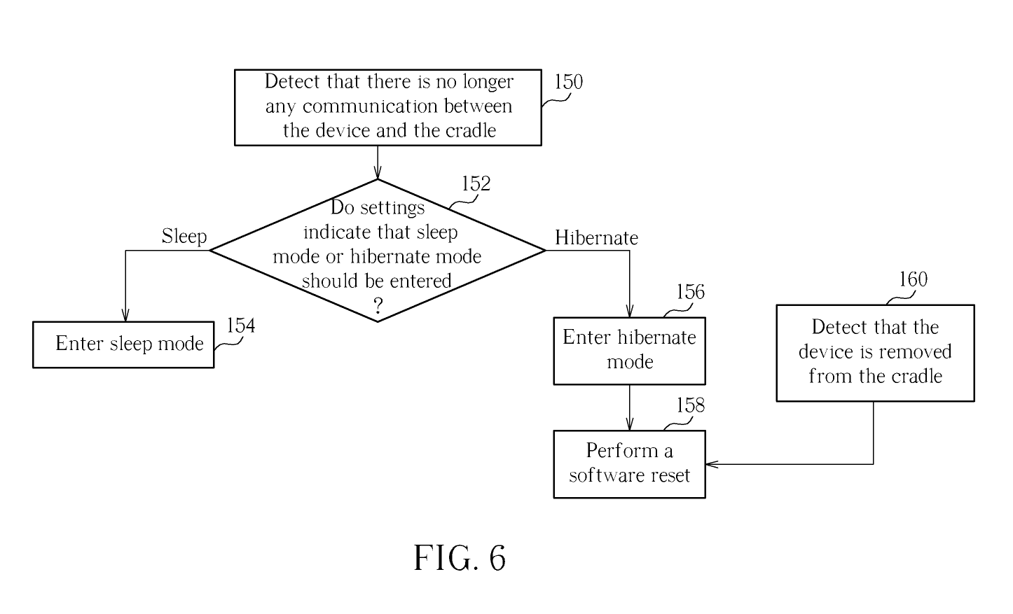

Please refer to FIG. 6. FIG. 6 is a flowchart illustrating the cradle 50 entering a sleep mode or hibernation mode when not in use. Steps contained in the flowchart will be explained below.

Step 150: Detect that there has not been any recent communication between the device and the cradle 50 for longer than a predetermined period of time.

Step 152: Determine if the cradle 50 should enter sleep mode or hibernate mode according to settings of the cradle 50. If sleep mode should be entered, go to step 154. If hibernate mode should be entered, go to step 156.

Step 154: The cradle 50 enters sleep mode.

Step 156: The cradle 50 enters hibernate mode.

Step 158: Perform a software reset on the cradle 50.

Step 160: Detect that the device is removed from the cradle 50. This may take place at any time, even while the cradle 50 and the device are communicating with one another. If the device has been removed from the cradle 50, go back to step 158.

In summary, the present invention cradle can work together with a mobile phone for providing accurate GPS signals to the mobile phone through the first connector of the cradle in order to allow the mobile phone to receive highly accurate GPS data signals. It is another advantage that the cradle contains a Bluetooth transceiver, a microphone, and a speaker for allowing the cradle to provide high quality speakerphone functionality for the mobile phone. Please note that any portable electronic device can be used with the cradle, so long as the portable electronic device can receive external GPS signals or can be used with external Bluetooth devices providing speakerphone functionality. Although the internal circuitry and the connector of the cradle may have to be redesigned for use with different mobile phones or portable electronic devices, the cradle is versatile enough that can be used to enhance the functionality of a variety of portable electronic devices.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of providing Global Positioning System (GPS) signals received by a cradle to a portable electronic device installed in the cradle, the method comprising:
mounting the portable electronic device in the cradle for establishing electrical connection between a first connector of the cradle and a second connector of the portable electronic device;
receiving GPS signals through a GPS receiver of the cradle;
converting the received GPS signals into GPS data signals;
transmitting the GPS data signals from the cradle to the portable electronic device via the first and second connectors; and
the portable electronic device using the GPS data signals for aiding the portable electronic device in determining current position coordinates of the portable electronic device.

2. The method of claim 1, further comprising:
providing a microphone in the cradle for converting voice data from a user of the cradle into sound data;
providing a Bluetooth transceiver in the cradle for transmitting sound data from the microphone to the portable electronic device and for receiving sound data from the portable electronic device; and
outputting sound data received from the portable electronic device via the Bluetooth transceiver through a speaker of the cradle.

3. The method of claim 2, further comprising providing an echo cancellation module installed in the cradle for removing echo from sound data sent via the Bluetooth transceiver.

4. The method of claim 1, further comprising utilizing an authentication chip of the cradle to send verification signals to the portable electronic device in order to verify that the cradle is approved for use with the portable electronic device.

5. The method of claim 1, wherein the GPS data signals received by the portable electronic device from the cradle are used to supplement GPS signals received directly by the portable electronic device for aiding the portable electronic device in determining the current position coordinates of the portable electronic device.

6. The method of claim 1, wherein the GPS data signals received by the portable electronic device from the cradle are solely used for aiding the portable electronic device in determining the current position coordinates of the portable electronic device.

7. The method of claim 1, wherein the portable electronic device is a mobile phone.

8. The method of claim 1, wherein the cradle enters a sleep mode or a hibernation mode if no communication between the cradle and the portable electronic device is detected for a predetermined period of time.

9. The method of claim 1, wherein when the portable electronic device detects that the second connector of the portable electronic device contacts the first connector of the cradle, the cradle begins a handshaking procedure for communicating with the portable electronic device.

10. The method of claim 9, wherein the portable electronic device detects that the second connector of the portable electronic device contacts the first connector of the cradle upon receiving power or data signals from the portable electronic device.

11. A cradle for providing Global Positioning System (GPS) signals received by the cradle to a portable electronic device installed in the cradle, the cradle comprising:
a first connector formed for receiving a second connector of the portable electronic device and establishing electrical connection between the first connector and the second connector when the portable electronic device is mounted in the cradle;
a GPS receiver for receiving GPS signals indicating a current position of the cradle; and
a processor for converting the received GPS signals into GPS data signals and transmitting the GPS data signals from the cradle to the portable electronic device via the first and second connectors;
wherein the portable electronic device uses the GPS data signals for aiding the portable electronic device in determining current position coordinates of the portable electronic device.

12. The cradle of claim 11, further comprising:
a microphone for converting voice data from a user of the cradle into sound data;
a Bluetooth transceiver for transmitting sound data from the microphone to the portable electronic device and for receiving sound data from the portable electronic device; and
a speaker for outputting sound data received from the portable electronic device via the Bluetooth transceiver.

13. The cradle of claim 12, further comprising an echo cancellation module for removing echo from sound data sent via the Bluetooth transceiver.

14. The cradle of claim 11, further comprising an authentication chip for sending verification signals to the portable electronic device in order to verify that the cradle is approved for use with the portable electronic device.

15. The cradle of claim 11, wherein the GPS data signals received by the portable electronic device from the cradle are used to supplement GPS signals received directly by the portable electronic device for aiding the portable electronic device in determining the current position coordinates of the portable electronic device.

16. The cradle of claim 11, wherein the GPS data signals received by the portable electronic device from the cradle are solely used for aiding the portable electronic device in determining the current position coordinates of the portable electronic device.

17. The cradle of claim 11, wherein the portable electronic device is a mobile phone.

18. The cradle of claim 11, wherein the cradle enters a sleep mode or a hibernation mode if the processor detects no communication between the cradle and the portable electronic device for a predetermined period of time.

19. The cradle of claim 11, wherein when the processor detects that the second connector of the portable electronic device contacts the first connector of the cradle, the processor begins a handshaking procedure for communicating with the portable electronic device.

20. The cradle of claim 19, wherein the processor detects that the second connector of the portable electronic device contacts the first connector of the cradle upon receiving power or data signals from the portable electronic device.
